(19) United States
(12) Patent Application Publication
(10) Pub. No.: US 2005/0035497 A1
(43) Pub. Date: Feb. 17, 2005

(54) Molded icon with texture difference from surrounding surface

(76) Inventor: Joseph A. Gutierrez, Thornton, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/639,174

(22) Filed: Aug. 12, 2003

(51) Int. Cl. B29C 33/42; B29C 45/00

(52) U.S. Cl. 264/328.1; 249/140

(57) ABSTRACT

One embodiment of the invention is an apparatus, comprising an icon associated with an operation of the apparatus, the icon being molded on a surface of the apparatus, wherein the icon has a texture that is different from a texture of a portion of the surface that surrounds the icon.

### FIELD OF THE INVENTION

The invention relates in general to molding, and in specific to a molded icon with texture difference from surrounding surface.

### BACKGROUND OF THE INVENTION

Electronic products typically have icons on their surfaces. These icons serve as visual aids for users and are intended to communicate important information about the operation of the product. For example, a copier or scanner may have an icon showing how the original document is to be located on the glass to properly copy/scan the document. Some icons may be printed on a separate item, and then attached, by glue, solder, fasteners, etc., to the product. Other icons may be painted onto a surface of the product. These methods are expensive because numerous steps or processes may be required to manufacture the icon and get it onto the surface of the device.

Another way to attach icons is to emboss or mold them into the surface of the device. This method is advantageous because it is less expensive: the icons can be applied as part of the molding process. Icons are typically used for aligning an input object (e.g. paper, photograph, or other object) on the input surface of a scanner, photocopier, and/or facsimile machine. Icons are typically inset into the surface of the device.

However, this method of providing icons does have a problem, namely the inset icon can be difficult for a user to see. The features of the inset icon can be hidden or obscured by the surrounding surface. In other words, the icon may blend in with the surface. If an icon cannot be seen, then its utility to the user, manufacturer, and product is significantly diminished.

One way to highlight the inset icon is to paint or print it. Painting or printing an icon, however, requires additional manufacturing steps and adds to the overall cost of the product. Furthermore, the paint or ink may be wear or fade over time.

### SUMMARY

One embodiment of the invention is an apparatus, comprising an icon associated with an operation of the apparatus, the icon being molded on a surface of the apparatus, wherein the icon has a texture that is different from a texture of a portion of the surface that surrounds the icon.

### BRIEF DESCRIPTION OF THE DRAWINGS

FIG. 1 depicts an example of an apparatus according to embodiments of the invention.

FIG. 2 depicts an example of a mold according to embodiments of the invention.

FIG. 3 depicts an example of a method according to embodiment of the invention.

### DETAILED DESCRIPTION

Embodiments of the invention preferably form an icon on or in a surface of an apparatus. This surface may be located on any portion of the apparatus, e.g. the housing, including the button(s) of the apparatus. In one embodiment, the icon is molded so that it has a different texture than that of the surrounding surface. The different texture visually and/or tactilely enhances the icon and allows a user to more readily find and/or view the icon in relation to the surrounding surface. In other words, the icon preferably has a first texture, and the surrounding surface has a second texture that is visually different from the first texture. Thus, the user may find and/or read (or view) the icon more easily since the icon has a noticeable contrast with the surrounding or adjacent surface.

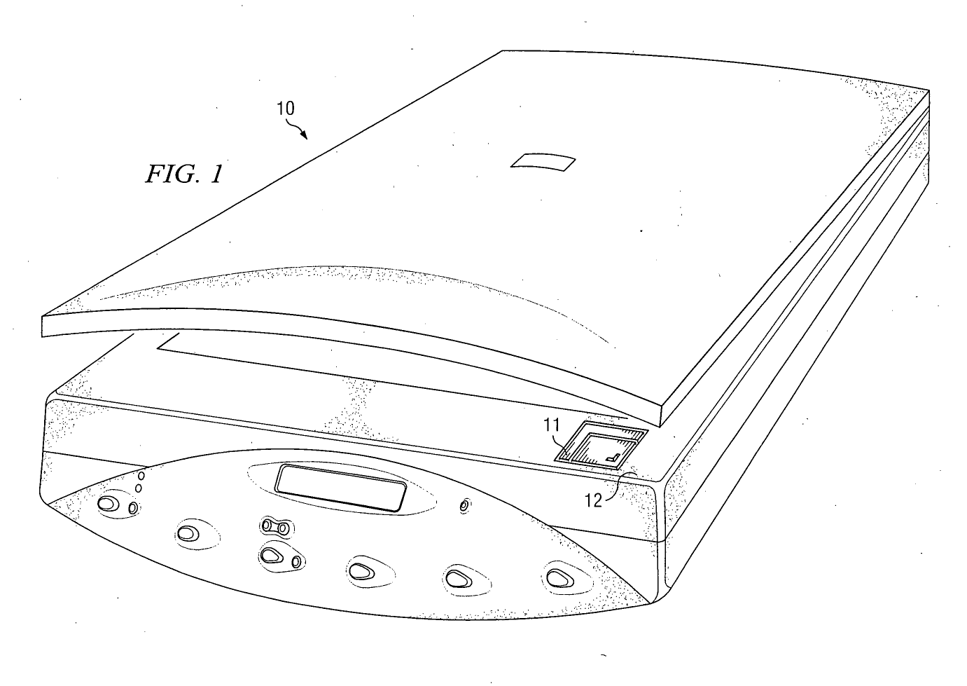

FIG. 1 depicts an example of an apparatus 10 having an exemplary embodiment of the invention. The apparatus 10 may be, for example, a scanner, a facsimile machine, a copier, or a computer; however, other apparatuses may have embodiments of the invention. A surface 12 of the apparatus 10 preferably includes an icon 11 that has been molded into the surface 12. As used herein, an icon is a pictorial representation that describes or depicts some information that is useful for operating the apparatus 10. For example, if the product is a scanner or copier, the information may indicate the proper location and/or alignment of an object that is to be scanned or copied. The icon may comprise a symbol (e.g. an arrow), a diagram (e.g. a picture of the apparatus with an input object properly placed on the input surface of the apparatus), text (e.g. a description of user choices for operation or a word (e.g. here)), a geometric shape (e.g. a diamond, a circle, a teardrop, an oval, or a rectangle), or a combination thereof. The icon may be located on a functional surface, e.g., a button or the icon may be located on a static surface, e.g., a housing or lever.

As shown in FIG. 1, the texture of the icon 11 is different than the texture of the surrounding surface. For example, the texture of the icon can be smoother or glossier than the texture of the surrounding surface, and this difference allows the contrast between the icon and the surrounding surface that allows the icon to be more readily located and/or read. An exemplary embodiment of the invention has the texture of the icon be a high gloss, and the texture of the surrounding surface 12 have a fine grained roughness. An alternative embodiment of the invention has the texture of the surrounding surface 12 smoother or glossier than the texture of the icon 11.

As shown in FIG. 1, the icon 11 is inset into the surface 12. As used herein, the term inset means below the surrounding surface. The inset arrangement enhances the visual perception of the differentiation of the icon 11 and the surface 12. The icon may be outset from the surface, or it may be molded level with the surface. As used herein, the term outset means protruding from the surface.

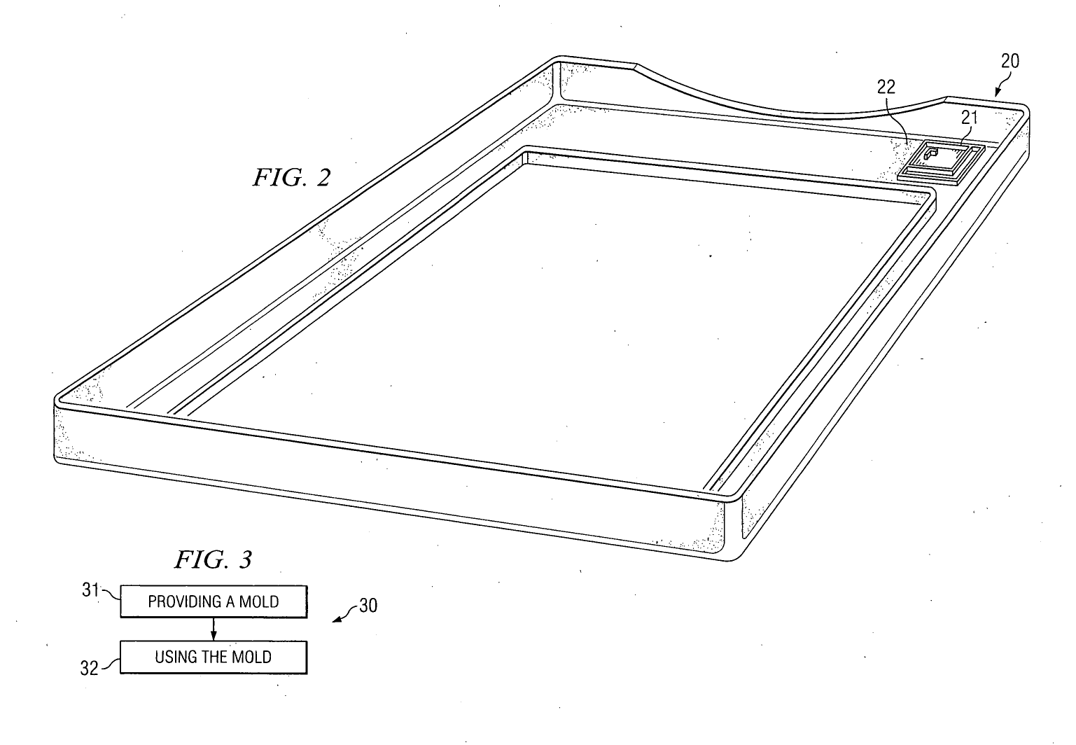

In one embodiment, the icon is machined into the steel mold into which plastic will be injected to form the plastic part. Accordingly, the icon is formed during the molding of the plastic part. Embodiments of the invention may also be formed from an embossing or stamping process, whereby the mold pattern is pressed into the material. Again, the finished part then has the shape and texture imparted onto it from the die. FIG. 2 depicts an example of a mold 20 associated with an embodiment of the invention. The mold 20 includes an area 21 that would form the icon, and an area 22 that would form the surrounding surface. As shown, the area 21 preferably has a different texture than the area 22. Area 21 is smoother or glossier than area 22.

FIG. 3 depicts an example of a method 30 according to embodiments of the invention. This method could be used to form a piece of the apparatus with the icon. This piece would then be assembled with other pieces to form the apparatus. The method begins in block 31 by providing a mold having a molding icon with a first texture and a surface that surrounds the molding icon with a second texture that is different from the first texture. In molding operations, a desired feature in the finished apparatus is represented in a reversed form on the mold. Thus, as used herein, a molding icon is a reversed form of the icon. In block 32, the mold would then be used in a molding operation to form the portion of the apparatus along with the icon. One example of a molding operation is an injection molding operation. This operation typically involves injecting a material into the mold, e.g. plastic. The material is then solidified by a change in temperature (e.g. heating or freezing), applying another material (e.g. a hardening agent), or by allowing the material to harden over time. The now solidified portion is removed from the mold, and is ready for assembly to form the apparatus. Another example of a molding operation is a stamping operation. The operation typically involves providing a sheet of material and pressing the mold into the material. This stamps the molding icon into or onto the material to form the icon. The mold is then removed from the material, the portion of the apparatus is ready to be used in the assembly of the apparatus.

1. An apparatus, comprising:
an icon associated with an operation of the apparatus, the icon being molded on a surface of the apparatus;
wherein the icon has a texture that is different from a texture of a portion of the surface that surrounds the icon.

2. The apparatus of claim 1, further comprising:
a housing;
wherein the icon is located on a surface of the housing.

3. The apparatus of claim 1, further comprising:
a button that has a function associated with the operation of the apparatus;
wherein the icon is located on a surface of the button.

4. The apparatus according to claim 1, wherein the apparatus is selected from the group consisting of:
a scanner, a facsimile machine, a copier, and a computer.

5. The apparatus according to claim 1, wherein the texture of the icon is smoother than the texture of the portion of the surface that surrounds the icon.

6. The apparatus according to claim 1, wherein the texture of the icon is glossier than the texture of the portion of the surface that surrounds the icon.

7. The apparatus according to claim 1, wherein the texture of the portion of the surface that surrounds the icon is smoother than the texture of the icon.

8. The apparatus according to claim 1, wherein the texture of the portion of the surface that surrounds the icon is glossier than the texture of the icon.

9. The apparatus according to claim 1, wherein the icon is inset into the surface.

10. The apparatus according to claim 1, wherein the surface of the apparatus comprises plastic.

11. The apparatus according to claim 1, wherein the icon identifies an alignment location for an input for the apparatus.

12. The apparatus according to claim 1, wherein the icon is selected from the group consisting of:
a symbol, a diagram, text, and a geometric shape.

13. A mold for forming a portion of an apparatus, the mold comprising:
means for forming an icon associated with an operation of the apparatus on the apparatus having a first texture; and
means for forming a surface that surrounds the icon, the surface having a second texture that is different from the first texture.

14. The mold of claim 13, wherein the means for forming the icon comprises:
means for forming the icon having the first texture be smoother than the second texture.

15. The mold of claim 13, wherein the means for forming the icon comprises:
means for forming the icon having the first texture be glossier than the second texture.

16. The mold of claim 13, wherein the means for forming the surface comprises:
means for forming the surface having the second texture be smoother than the first texture.

17. The mold of claim 11, wherein the means for forming the surface comprises:
means for forming the surface having the second texture be glossier than the first texture.

18. A method for forming an icon on a portion of apparatus, the method comprising:
providing a mold having a molding icon with a first texture and a surface that surrounds the molding icon with a second texture that is different from the first texture; and
using the mold in a molding operation to form the icon on the portion of the apparatus.

19. The method of claim 18, wherein the molding operation is an injection molding operation, and using the mold comprises:
injecting a material into the mold;
solidifying the material; and
removing the portion of the apparatus from the mold.

20. The method of claim 18, wherein the molding operation is a stamping operation, and using the mold comprises:
providing a piece of material;
pressing the mold into the material; and
removing the mold from the material.
